(19) United States
(12) Patent Application Publication
(10) Pub. No.: US 2007/0028107 A1
(43) Pub. Date: Feb. 1, 2007

(54) Prescription Authentication

(75) Inventors: Russell Paul Cowburn, London (GB); James David Ralph Buchanan, London (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: INGENIA HOLDINGS (UK) LIMITED, London (GB)

(21) Appl. No.: 11/460,540

(22) Filed: Jul. 27, 2006

Related U.S. Application Data
(60) Provisional application No. 60/702,746, filed on Jul. 27, 2005.

(30) Foreign Application Priority Data
Jul. 27, 2005 (GB) 0515464.6

(51) Int. Cl. G06Q 10/00; H04L 9/00; G06Q 50/00

(52) U.S. Cl. 713/172; 705/2; 713/176

(57) ABSTRACT

The invention relates to a system 100 for verifying the authenticity of medicament entitlement tokens, such as prescriptions 102, used to control the dispensing of medicaments. The system comprises a network 104 connecting at least one token provider terminal 106, a system server 120 and a verification terminal 130. The token provider terminal 106 is operable to provide a signature from a speckle pattern derived from a medicament entitlement token that can be stored by the server system 120. The verification terminal 130 can then be operated remotely to recreate the signature in order to verify the authenticity of the medicament entitlement token by comparing it to stored signatures. The system 100 relies upon the intrinsic physical properties of the medicament entitlement token to generate a unique signature for each token that is produced. This makes the medicament entitlement tokens themselves very difficult to forge. Moreover, the signatures transmitted over the network do not need to contain any details relating to the content of the medicament entitlement tokens, such as patient data, hence signature data stored by the system can be made privacy neutral so that even if it were to be intercepted or copied this would not compromise confidentiality.

This application claims priority to and incorporates by reference U.S. provisional application No. 60/702,746 filed on Jul. 27, 2005, and Great Britain patent application GB 0515464.6 filed on Jul. 27, 2005.

### FIELD

The invention relates to prescription authentication. In particular, the invention relates to a system and method for verifying the authenticity of prescriptions used to control the dispensing of medicaments.

### BACKGROUND

In many healthcare systems, it is common for patients to visit a doctor in order to obtain a prescription for various drugs needed to treat their ailments. Often the prescription takes the form of a paper document that is prescribed by the doctor adding information relating to the patient (e.g. personal information such as name, address, existing allergies etc.) and to the drugs to be dispensed (e.g. drug/medicament type, dose, dosing regime etc.), and is also signed by the doctor for validation purposes.

Having obtained a valid prescription, following a diagnosis by the doctor and subsequent prescribing, the patient may be required to take the prescription from the doctor's surgery to a pharmacy, or other dispensary, in order to exchange the prescription for one or more prescribed drugs. Such a pharmacy may be located at a location that is remote from the doctor's surgery, and so may mean that presentation of the prescription can only be made a significant amount of time after the prescription is produced. During the period between production and presentation, a prescription may be tampered with or substituted to fraudulently gain access to controlled drugs. This is a particular problem for paper-based prescriptions which are fairly easy to modify or forge, especially if a fraudster has access to authentic prescription paper.

Various devices and systems are known for aiding in the preparation and management of prescriptions for dispensing medicaments [1-6], including various ones that incorporate security aspects used to identify patients [3-6].

Certain prescription management systems rely upon the use of electronic devices, such as smart cards, to convey information to a pharmacist relating to the type and quantity of drugs to be dispensed [3-5]. Since smart cards can provide an inherent level of security, the use of smart cards to control access to drugs can help prevent fraudulent access to prescription medicaments as they allow for the secure writing of prescription information without the bearer of the smart card being easily able to modify that information.

However, although smart card systems may be more secure than traditional paper-based prescription systems in certain respects, paper based prescription systems are still ubiquitous. Therefore, if there were to be any wide-spread adoption of smart card based systems, large scale replacement of existing prescription production and management systems would be required. This would require large investment in new capital equipment and would require doctors to adopt new working practices (e.g. by using electronic signatures to authenticate prescription data held in a smart card). As such the prospect of universal adoption of smart card based systems is not presently either practical or cost-effective.

Accordingly, there is a need for an improved security scheme for controlling and managing access to medicinal products using existing types of prescription.

### SUMMARY OF THE INVENTION

According to a first aspect of the invention, there is provided a system for verifying the authenticity of prescriptions used to control the dispensing of medicaments. The system comprises a network for providing one or more communications channels between devices operably coupled thereto, and a token provider terminal provided at a first location and operably coupled to the network, the token provider terminal being operable to generate a first signature from a medicament entitlement token that is prescribed at the first location based upon a speckle pattern generated by illuminating the medicament entitlement token with coherent radiation. In various embodiments, the medicament entitlement token comprises a prescription printed on paper.

The system also comprises a system server operably coupled to the network, the system server being operable to store a plurality of signatures transmitted over the network from one or more token provider terminals, the system server being further operable to compare a signature transmitted over the network with stored signatures and transmit a response message indicating whether or not the transmitted signature is considered to match any stored signature.

Additionally, the system includes a verification terminal operably coupled to the network and provided at a second location remote from the first location. The verification terminal is operable to verify the authenticity of a medicament entitlement token presented at the second location by generating a second signature from the presented medicament entitlement token based upon a speckle pattern generated by illuminating the presented medicament entitlement token with coherent radiation, transmitting the second signature to the system server via the network, receiving a response message over the network and identifying as authentic the presented medicament entitlement token where the response message indicates there is a match between the second signature and a stored signature.

The system relies upon the intrinsic physical properties of the medicament entitlement token to generate a unique signature for each token that is produced. This makes the medicament entitlement tokens themselves very difficult to forge and also provides a system that is robust at rejecting replacement medicament entitlement tokens, even if they are produced using, for example, genuine prescription paper. Moreover, the signatures transmitted over the network do not need to contain any details relating to the patient, hence signature data stored by the system can be made privacy neutral so that even if it were to be intercepted or copied this would not compromise patient confidentiality.

According to a second aspect of the invention, there is provided a method for verifying the authenticity of prescriptions used to control the dispensing of medicaments. The method comprises prescribing a medicament entitlement token at a first location, generating a first signature at the first location based upon a speckle pattern generated by illuminating the medicament entitlement token with coherent radiation, transmitting the signature to a system server, storing the signature at the system server, generating a second signature from a presented medicament entitlement token at a second location remote from the first location, wherein the second signature is based upon a speckle pattern generated by illuminating the presented medicament entitlement token with coherent radiation, transmitting the second signature to the system server, identifying whether the second signature matches any signatures stored by the server system, generating a response message identifying whether or not the second signature matches a stored signature, transmitting the response message to the second location, and verifying that the presented token is authentic at the second location where the response message indicates there is a match between the second signature and a stored signature.

### BRIEF DESCRIPTION OF THE DRAWINGS

FIG. 1 shows a system for verifying the authenticity of prescriptions according to an embodiment of the present invention;

FIG. 2 shows a method for verifying the authenticity of prescriptions according to the present invention;

FIG. 3 shows a reader apparatus for use in various embodiments of the present invention;

FIG. 4 shows a schematic perspective view of how the reading volume of the reader apparatus of FIG. 3 is sampled;

FIG. 5 shows a block schematic diagram of the functional components of the reader apparatus of FIG. 3;

FIG. 6 shows a perspective view of the reader apparatus of FIG. 3, showing its external form;

FIG. 7 shows an alternative physical configuration of a reader apparatus for use in various embodiments of the present invention;

FIG. 8 shows further alternative physical configurations of a reader apparatus for use in various embodiments of the present invention;

FIG. 9 shows a schematic view of a reader apparatus incorporated in a printing device for use in various embodiments of the present invention;

FIG. 10A shows schematically in side view an alternative imaging arrangement for a reader apparatus for use in various embodiments of the present invention;

FIG. 10B shows schematically in plan view the optical footprint of a further alternative imaging arrangement for a reader apparatus for use in various embodiments of the present invention in which directional detectors are used in combination with localised illumination by an elongate beam;

FIG. 11 is a microscope image of a paper surface with the image covering an area of approximately 0.5×0.2 mm;

FIG. 12A shows raw data from a single photodetector of the reader apparatus of FIG. 3 which consists of a photodetector signal and an encoder signal;

FIG. 12B shows the photodetector data of FIG. 12A after linearisation with the encoder signal and averaging of the amplitude;

FIG. 12C shows the data of FIG. 12B after digitisation according to the average signal level to provide data that can be used to obtain a signature;

FIG. 13 is a flow diagram showing how a signature is generated from a speckle pattern generated by illuminating a prescription with coherent radiation according to various embodiments of the present invention;

FIG. 14 is a flow diagram showing how a signature obtained from a presented prescription can be verified against a signature database to determine whether the presented prescription is authentic according to various embodiments of the present invention;

FIG. 15 is a flow diagram showing how the verification process of FIG. 14 can be altered to account for non-idealities in a scan;

FIG. 16A shows an example of cross-correlation data gathered from a scan;

FIG. 16b shows an example of cross-correlation data gathered from a scan where the scanned article is distorted;

FIG. 16C shows an example of cross-correlation data gathered from a scan where the scanned article is scanned at non-linear speed;

FIG. 17 is a schematic representation of an article for authenticity verification.

FIG. 18 is a schematic cut-away perspective view of a multi-scan head scanner; and

FIG. 19 is a schematic cut-away perspective view of a multi-scan head position scanner.

### DETAILED DESCRIPTION

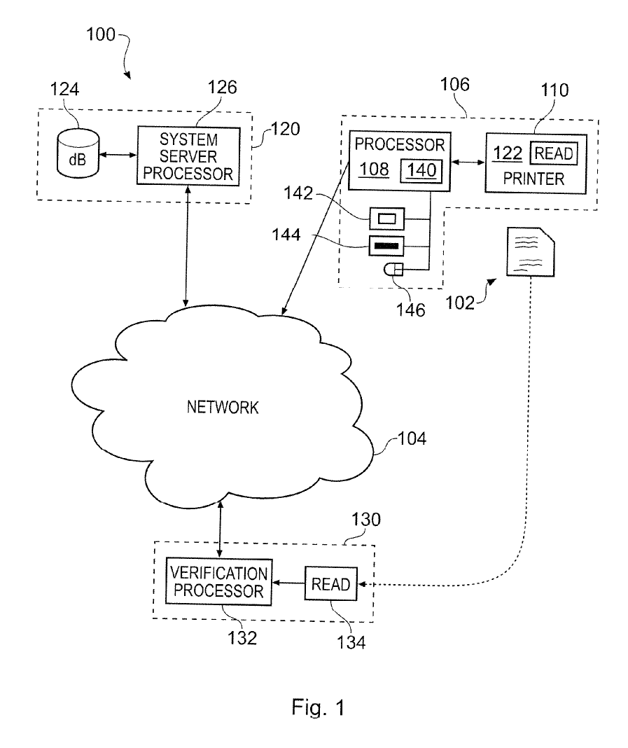

FIG. 1 shows a system 100 for verifying the authenticity of medicament entitlement tokens, such as a prescription 102. The system 100 comprises a token provider terminal 106, a system server 120 and a verification terminal 130 operably connected together through a network 104. The network 104 can, for example, be based upon publicly available dedicated fixed or mobile telephone services, private telecommunications links, etc. operating according to any one or more desired transmission protocol (e.g. Internet (TCP/IP), short message service (SMS) messaging, international standard dialing network (ISDN) etc.). In operation, the network 104 provides one or more communications channels between devices to which it is operably coupled.

The token provider terminal 106 is provided at a first location, such as, for example, a doctor's surgery. The token provider terminal 106 comprises a processor 108 that is operable to provide a user interface 140 that enables a user of the token provider terminal 106 to prescribe the prescription 102. The user interface 140 presents a prescription template (not shown) to the user on a display device 142. Using input devices, such as keyboard 144 and mouse 146, the user can fill in the prescription template presented on the display device 142. For example, a doctor can add patient related data such as patient name, age and address as well as medicament related data such as drug type, quantity and dosing regime to be prescribed to the patient to fill in the template.

Once the prescription template has been filled in, the processor 108 is operable to format the data necessary to produce the prescription 102. The formatted data may be used to complete a pre-printed prescription form (e.g. possibly having printed thereon the surgery details, doctor's name, a prescription identity number, etc.) which has space available for printed patient and medicament related data. The formatted data is spooled by the processor 108 to a printing device 122, where it is printed onto paper or the pre-printed prescription form to produce the prescription 102.

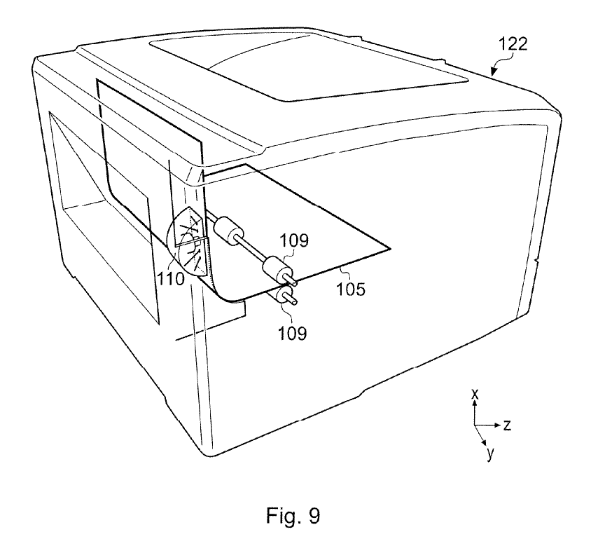

In this embodiment, the printing device 122 also contains a reader apparatus 110. FIG. 9 illustrates the construction of such a printing device 122 in further detail.

The reader apparatus 110 is operable to illuminate the prescription 102 with coherent radiation either before, during or after printing, and to acquire data relating to the speckle pattern produced when radiation scatters from the prescription. The use of speckle pattern discrimination to identify the prescription 102 makes it very difficult to forge, since any forger needs to recreate the speckle pattern if he is to fool the system 100 into identifying a forgery as authentic.

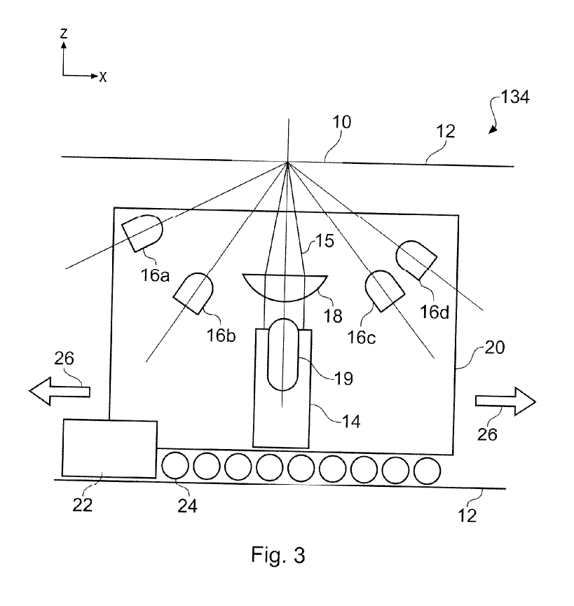

The data acquired from the speckle pattern may correspond to a two-dimensional image of the speckle pattern, for example, obtained using a charge coupled delay (CCD) camera. However, in the embodiment illustrated, an alternative data acquisition scheme is used in which the acquired data forms a set of data points obtained as point samples of one or more speckle pattern. Various examples of reader apparatus operating using the latter alternative type of data acquisition scheme are described below in connection with FIGS. 3 to 10, these are advantageous as they do not need complex image processing or highly accurate image registration for recognition to be effective.

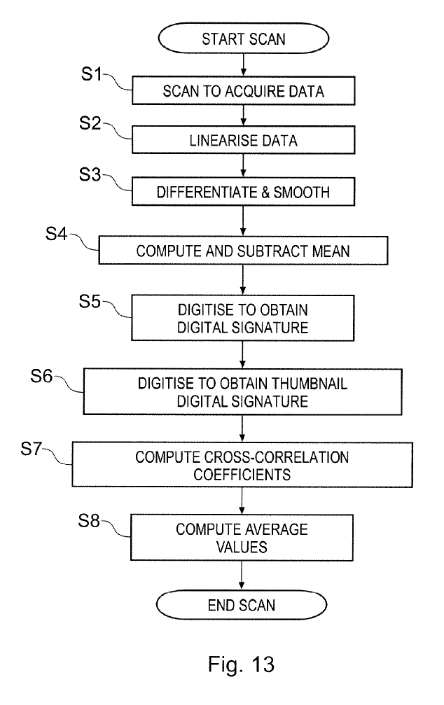

The processor 108 is operable to generate a first signature from the acquired data. The process for doing this is described in more detail below in connection with FIG. 13.

Once the first signature has been generated the processor 108 can transmit it to the server system 102 via the network 104. Since the signatures generated by the system 100 depend upon the intrinsic physical properties of the (e.g. paper) substrate forming the prescription 102, and not necessarily upon any information written on the prescription 102, data that is transmitted over the network 104 is privacy neutral: e.g. the signature data on its own does not reveal information regarding the patient or the medicaments to be dispensed.

Optionally, the token provider terminal 106 can be operable to provide additional information relating to the prescription 102 to the server system 120 via the network 104. For example, information entered at the user interface 140 could be transmitted along with the signature, for example, in encrypted form. Such information may be patient anonymous: e.g. medicine type, dosage, prescription creation date/time, prescription expiry date/time, location, patient age, number, pre-existing medical conditions etc. This information may be used anonymously at the system server 120, or elsewhere, to derive useful medical statistics, such as, for example, for studying the geographical dispensing pattern of certain types of drugs for use in epidemiological studies. In another example, where a patient is directly or indirectly identifiable (e.g. by assignation of patient numbers), the system server 120 could be used automatically to check prescriptions for any medical contraindications, and issue warnings to the token provider terminal 106 if any occur.

In another optional mode of operation, the token provider terminal 106 is operable to generate a bearer identification signature based upon a speckle pattern generated by illuminating an identification token with coherent radiation. The bearer identification signature may be generated using the reader apparatus 110, or by another reader device provided at the first location. The bearer identification signature can be transmitted to the server system 120 over the network 104.

It is envisaged that the bearer identification signature be generated from a token that is unique to the bearer, who in this case could be the patient for whom the prescription 102 is produced. Such bearer tokens may include, for example, a passport, an identification (ID) card, a medical insurance card etc. These can be scanned by a doctor at the first location where the prescription is prepared and again when the prescription 102 is presented, so linking the patient/bearer token to the prescription using a pair of signatures in a way that is also privacy neutral. This mode provides an extra level of security as it can be mad a requirement that the original bearer token be presented with the prescription 102 in order to obtain any benefit, such as dispensing of drugs.

In the optional modes of operation where a patient may be required to present a form of identification to a doctor in order to be given a prescription, the mere fact that a identification is needed may in itself be enough to deter fraud since anyone wishing to redeem a prescription could be compelled to present their own identification at a pharmacy for scanning. If a presented identification fails to match the prescription the bearer would already have either identified themselves, where their identification was genuine, or have presented false identification. Such cases could be recorded. Where the identification is a photo-identification such a mode of system operation is particularly effective as a deterrent. Moreover, the identification need not necessarily be identified using speckle analysis (i.e. the ways of identifying the prescription and the identification need not be the same techniques). For example, identification could be checked using a simple bar code reader.

The system server 120 is operable to store a plurality of signatures transmitted over the network 104 from one or more token provider terminals 106. The system server 120 comprises a database 124 for storing and managing the signatures. The database 124 in this embodiment may, for example, be provided by Oracle™ database software and a redundant array of independent disks (RAID) storage device for added data integrity. The server system 102 may also be operable to store and compare further information received over the network 104 or bearer identification signatures.

The verification terminal 130 is operably coupled to the network 104 at a second location remote from the first location. The verification terminal 130 is also operable to verify the authenticity of a prescription presented at the second location by generating a second signature from the presented medicament entitlement token based upon a speckle pattern generated by illuminating the presented prescription with coherent radiation. The signature is generated from data obtained by scanning the presented prescription using a reader apparatus 134 of the type shown in FIG. 3, although other types of reader apparatus may be used instead.

The verification terminal 130 comprises a verification processor 132. The verification processor 132 acquires data from the reader apparatus 134 as a set of data points obtained as point samples of one or more speckle pattern. Once sufficient data has been acquired, the verification processor 132 is operable to generate the second signature from the acquired data. Optionally, the verification terminal 132 may also be used to generate bearer identification signatures from a bearer token, in addition to the second signature, for verifying the identity of a person presenting the prescription 102. The process for generating the signatures is described in more detail below in connection with FIG. 13.

The second signature, and optionally a bearer identification signature, is/are transmitted by the verification terminal 130 to the system server 120 via the network 104. The system server 120 is operable to compare the transmitted second signature with signatures stored in the database 124. If there is no match between the second signature and a signature stored in the database 124, then it is assumed that the prescription 102 is not authentic. If there is a match, the prescription 102 is assumed to be authentic.

Where a bearer identification signature is also transmitted, the system server 120 is operable to compare the bearer identification signature with bearer identification signatures stored in the database 124. If there is no match between the bearer identification signature and a signature stored in the database, then it is assumed that the bearer of the prescription is not entitled to use the prescription 102. If there is a match, the bearer may be assumed to be entitled to use the prescription 102, possibly subject to a visual check of the bearer token by an operator at the second location, or by cross-checking prescription or patient information held in the database 124 with information on the presented prescription or the bearer's credentials.

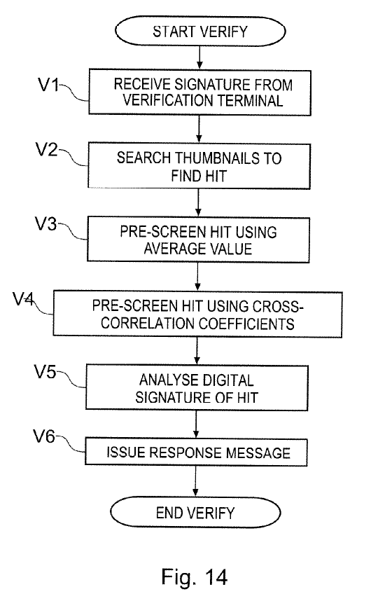

The process of matching signatures to determine whether a signature matches one stored in the database 124 is described in detail below, in connection with FIG. 14.

The system server 120 is operable to generate a response message and to transmit it to the verification terminal 130 over the network 104. The content of the response message indicates whether or not the prescription 102 is authentic, and optionally, whether the bearer is entitled to use that prescription 102. The content of the message can be presented to a user of the verification terminal 130, for them to take appropriate action: e.g. honouring an authentic prescription, canceling or destroying a non-authentic prescription and, if appropriate, informing the relevant law enforcement authorities.

The server system 120 may additionally be operable to fully or partially invalidate prescriptions. For example, where a prescription relates to the dispensing of more than one medicament and not all of the item are available, a pharmacist may dispense available items and use the verification terminal 130 to indicate to the server system 120 that the corresponding prescription remains only partially valid. In this way when the prescription is presented again in respect of the remaining items, the server system 120 can indicate to the verification terminal 130 in the message only those items that remain to be dispensed.

Also, if certain data is stored in the database 124 with a corresponding signature (e.g. data relating to the originating doctor, and date/time of submission to the database), then it is easy to block a prescription beyond any specified date. For example, an antibiotic prescription for a bacterial infection might be specified to be dispensed within a week of the prescription being produced, whereas a repeat prescription for a chronic condition, e.g. asthma, may be allowed to be dispensed up to several months from production of the prescription.

Additionally, a one-to-one correspondence may be determined between issued prescriptions and dispensed drugs or medicines. This provides an audit trail can be generated in a manner which provides useful information but remains privacy neutral as there is no need to store patient data in the database in order to create the audit trail.

The verification terminal 130 or server system 120 may be operable automatically to track an inventory at the second location. For example, the verification terminal 130 could alert a pharmacist when supplies of a drug fall below a certain level or if drugs in stock have not been dispensed by their use by date. In another example, the server system 120 could be used to track inventory, thereby freeing up resources at verification terminals. Such a server system 120 could be used, for example, by drug companies to perform geographical analysis of product stock levels/dispensing levels etc., which could then be used for marketing purposes or to spot disease trends/patterns. Where inventory tracking is used, the verification terminal 130 or server system 120 may be further operable automatically to place an order to a supplier over the network for replacement stock when the stock of one or more items in the inventory falls to or below a predetermined amount, e.g. by ordering drugs from a particular pharmaceutical supplier in batches if necessary.

The processor 108 or verification processor 132 may be provided as part of a suitably configured personal computer (PC) provided at the first or second location. By configuring one or more PCs in this way, existing equipment can be used without requiring the provision of specialist hardware other than the addition of various reader apparatus into the system.

Moreover, since digitised signatures may only comprise a relatively small amount of data (e.g. 200 bits to 8 kilobits), verification at the system server 120 may be a fairly rapid process. In addition, the bandwidth of communications channels provided by the network 104 can be relatively low. For example, a 56 k dial-up modem may be used by a token provider terminal 106 or a verification terminal 130 to connect to the network 104, thereby enabling the use of inexpensive standard equipment at the first and second locations.

Various devices suitable for use in a system provided according to the present invention are also described in various of the present applicant's co-pending patent applications [7-14].

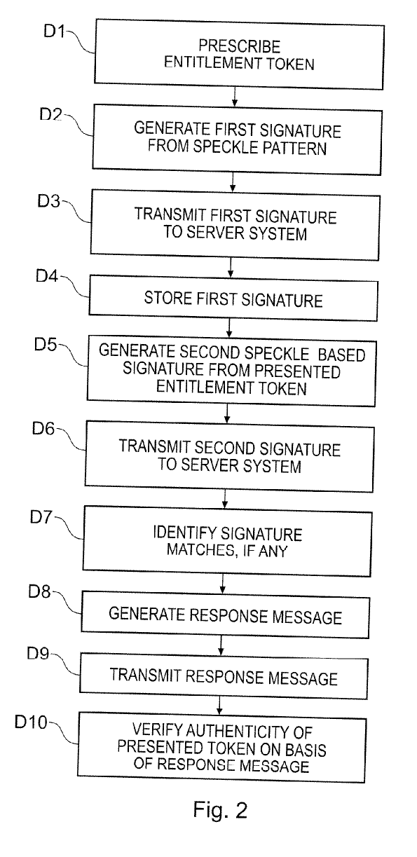

FIG. 2 shows a method for verifying the authenticity of prescriptions.

At step D1, the method comprises prescribing a medicament entitlement token, such as prescription 102, at a first location. The medicament entitlement token may be prescribed at the first location, for example, by a doctor operating a user interface to input prescription information for filling in a prescription, or by the doctor producing a hand-written prescription. There does not need to be any externally generated data provided from a location external to the first location for prescribing to occur. In other words, all the prescribing steps needed to produce the medicament entitlement token can be taken at the first location only.

At step D2, a first signature is generated at the first location based upon a speckle pattern generated by illuminating the medicament entitlement token with coherent radiation.

At step D3, the first signature is transmitted to a system server.

At step D4, the signature is stored at the system server.

At step D5, a second signature is generated from a presented medicament entitlement token at a second location remote from the first location. The second signature is based upon a speckle pattern generated by illuminating the presented medicament entitlement token with coherent radiation.

At step D6, the second signature is transmitted to the system server.

At step D7, the step of identifying whether the second signature matches any signatures stored by the server system is performed.

At step D8, a response message is generated identifying whether or not the second signature matches a stored signature.

At step D9, the response message is transmitted to the second location.

At step D10, the step of verifying that the presented token is authentic at the second location is performed where the response message indicates there is a match between the second signature and a stored signature.

The method steps D1 to D10 may be implemented by the system 100 shown in FIG. 1. For example: steps D1 to D3 may be performed by the token provider terminal 106 shown in FIG. 1; steps D4, D7, D8 and D9 by the system server 120; and steps D5, D6 and D10 by the verification terminal 130.

FIG. 3 shows a first example of a reader apparatus 134. The optical reader apparatus 134 is for measuring a signature from a token, such as, for example, a printed prescription (not shown), arranged in a reading volume of the apparatus. The reading volume is formed by a reading aperture 10 which is a slit in a housing 12. The housing 12 contains the main optical components of the apparatus. The slit has its major extent in the x direction (see inset axes in the drawing).

The principal optical components are a laser source 14 for generating a coherent laser beam 15 and a detector arrangement 16 made up of a plurality of k photodetector elements, where k=4 in this example, labelled 16a, 16b, 16c and 16d. The laser beam 15 is focused by a cylindrical lens 18 into an elongate focus extending in the y direction (perpendicular to the plane of the drawing) and lying in the plane of the reading aperture. In one example reader, the elongate focus has a major axis dimension of about 2 mm and a minor axis dimension of about 40 micrometres. These optical components are contained in a subassembly 20.

In the present example, the four detector elements 16a . . . d are distributed either side of the beam axis offset at different angles in an interdigitated arrangement from the beam axis to collect light scattered in reflection from a token present in the reading volume. In the present example, the offset angles are −70, −20, +30 and +50 degrees. The angles either side of the beam axis are chosen so as not to be equal so that the data points they collect are as independent as possible. All four detector elements are arranged in a common plane. The photodetector elements 16a . . . d detect light scattered from a token placed on the housing when the coherent beam scatters from the reading volume. As illustrated, the source is mounted to direct the laser beam 15 with its beam axis in the z direction, so that it will strike a token in the reading aperture at normal incidence.

Generally it is desirable that the depth of focus is large, so that any differences in the token positioning in the z direction do not result in significant changes in the size of the beam in the plane of the reading aperture. In the present example, the depth of focus is approximately 0.5 mm which is sufficiently large to produce good results where the position of the token relative to the scanner can be controlled to some extent. The parameters, of depth of focus, numerical aperture and working distance are interdependent, resulting in a well known trade off between spot size and depth of focus.

A drive motor 22 is arranged in the housing 12 for providing linear motion of the optics subassembly 20 via suitable bearings 24 or other means, as indicated by the arrows 26. The drive motor 22 thus serves to move the coherent beam linearly in the x direction over the reading aperture 10 so that the beam 15 is scanned in a direction transverse to the major axis of the elongate focus. Since the coherent beam 15 is dimensioned at its focus to have a cross-section in the xz plane (plane of the drawing) that is much smaller than a projection of the reading volume in a plane normal to the coherent beam, i.e. in the plane of the housing wall in which the reading aperture is set, a scan of the drive motor 22 will cause the coherent beam 15 to sample many different parts of the reading volume under action of the drive motor 22.

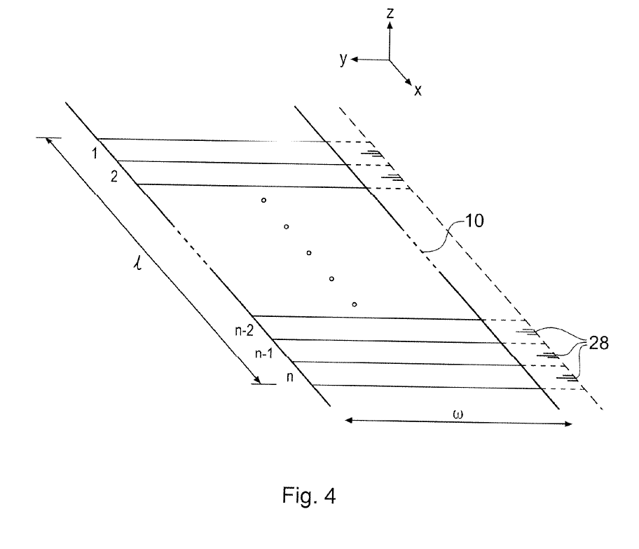

FIG. 4 is included to illustrate this sampling and is a schematic perspective view showing how the reading area is sampled n times by scanning an elongate beam across it. The sampling positions of the focused laser beam as it is scanned along the reading aperture under action of the drive is represented by the adjacent rectangles numbered 1 to n which sample an area of length ‘1’ and width ‘w’. Data collection is made so as to collect signal at each of the n positions as the drive is scanned along the slit. Consequently, a sequence of k×n data points are collected that relate to scatter from the n different illustrated parts of the reading volume.

Also illustrated schematically are optional distance marks 28 formed on the underside of the housing 12 adjacent the slit 10 along the x direction, i.e. the scan direction. An example spacing between the marks in the x-direction is 300 micrometres. These marks are sampled by a tail of the elongate focus and provide for linearisation of the data in the x direction in situations where such linearisation is required, as is described in more detail further below. The measurement is performed by an additional phototransistor 19 which is a directional detector arranged to collect light from the area of the marks 28 adjacent the slit.

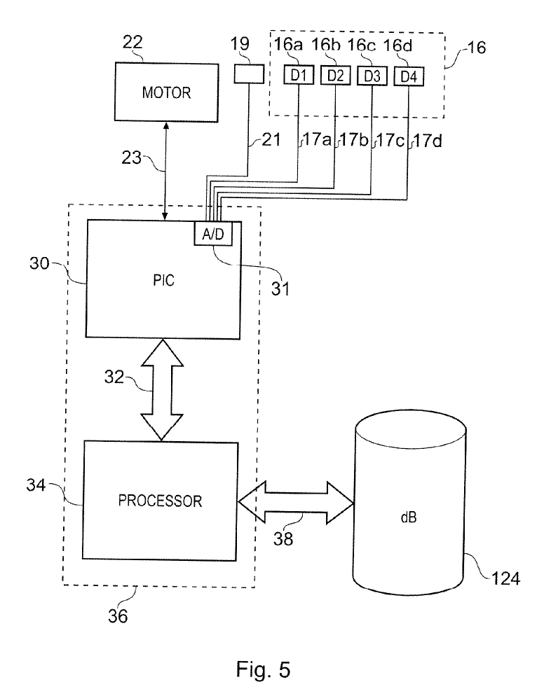

In alternative examples, the marks 28 can be read by a dedicated encoder emitter/detector module 19 that is part of the optics subassembly 20. Encoder emitter/detector modules are used in bar code readers. In one example, an Agilent HEDS-1500 module that is based on a focused light emitting diode (LED) and photodetector can be used. The module signal is fed into the PIC ADC as an extra detector channel (see discussion of FIG. 5 below).

With an example minor dimension of the focus of 40 micrometers, and a scan length in the x direction of 2 cm, n=500, giving 2000 data points with k=4. A typical range of values for k×n depending on desired security level, token type, number of detector channels ‘k’ and other factors is expected to be 100<k×n<10,000. It has also been found that increasing the number of detectors k also improves the insensitivity of the measurements to surface degradation of the token through handling, printing etc. In practice, with the prototypes used to date, a rule of thumb is that the total number of independent data points, i.e. k×n, should be 500 or more to give an acceptably high security level with a wide variety of surfaces. Other minima (either higher or lower) may apply where a scanner is intended for use with only one specific surface type or group of surface types.

FIG. 5 shows a block schematic diagram of the functional components of the reader apparatus 134 of FIG. 3. The motor 22 is connected to a programmable interrupt controller (PIC) 30 through an electrical link 23. The detectors 16a . . . d of the detector module 16 are connected through respective electrical connection lines 17a . . . d to an analogue-to-digital converter (ADC) that is part of the PIC 30. A similar electrical connection line 21 connects the marker reading detector 19 to the PIC 30. It will be understood that optical or wireless links may be used instead of, or in combination with, electrical links. The PIC 30 is interfaced with a processor 34 through a data connection 32.

In the system 100 that is described above, the functions provided by the processor 34 and the verification processor 132 can be provided by the same electronic device, programmed accordingly. The processor 34 may be part of a desktop or a laptop computer system, for example. As an alternative, other intelligent devices may be used, for example a personal digital assistant (PDA) or a dedicated electronics unit. The PIC 30 and processor 34 collectively form a data acquisition and processing module 36 for determining a signature of the token from the set of data points collected by the detectors 16a . . . d.

In some examples, the processor 34 can have access through an optional network interface connection 38 provided through the network 104 to the system server database 124. Such access through the network 104 may be by wireless communication, for example using mobile telephony services, or a wireless local area network (LAN) in combination with the Internet.

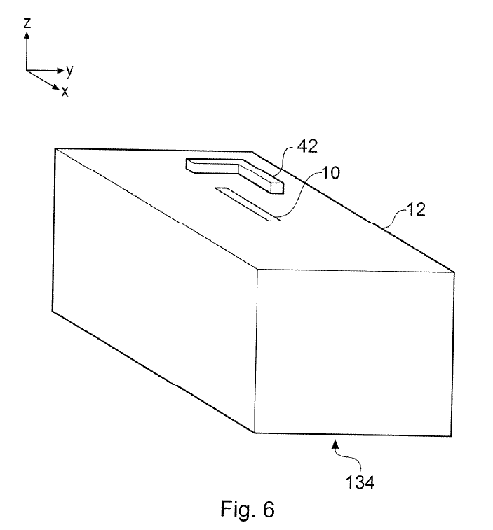

FIG. 6 shows a perspective view of the reader apparatus 134 showing its external form. The housing 12 and slit-shaped reading aperture 10 are evident. A physical location aid 42 is also apparent and is provided for positioning a token of a given form in a fixed position in relation to the reading aperture 10. In the present example, the physical location aid 42 is in the form of a right-angle bracket in which the corner of a token, such as a prescription document can be located. This ensures that the same part of the token can be positioned in the reading aperture 10 whenever the token needs to be scanned. A simple angle bracket or equivalent, is sufficient for tokens with a well-defined corner, such as sheets of paper, passports, ID cards, etc. However, other shaped position guides could be provided to accept tokens of different shapes, such as circular tokens or tokens with curved surfaces. Where only one size and shape of token is to be scanned a slot may be provided for receiving the token.

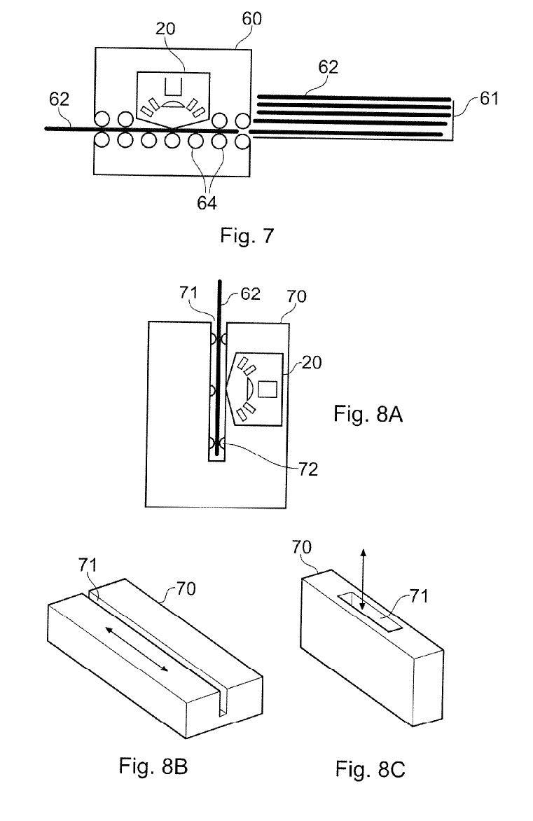

FIG. 7 shows an alternative physical configuration of a reader apparatus where a document feeder is provided to ensure that token placement is consistent. In this example, a housing 60 is provided, having a token feed tray 61 attached thereto. The tray 61 can hold one or more tokens 62 for scanning by the reader. A motor can drive feed rollers 64 to carry a token 62 through the device and across a scanning aperture of an optics subassembly 20 as described above. Thus the token 62 can be scanned by the optics subassembly 20 in the manner discussed above in a manner whereby the relative motion between optics subassembly and token is created by movement of the token.

Using such a reader apparatus, the motion of the scanned item can be controlled using the motor with sufficient linearity that the use of distance marks and linearisation processing may be unnecessary. The reader apparatus could follow any conventional format for document scanners, photocopiers or document management systems. For example, such a reader apparatus may be configured to handle line-feed sheets (where multiple sheets are connected together by, for example, a perforated join) as well as or instead of handing single sheets, double-sided tokens, etc.

Thus there has now been described a reader apparatus suitable for scanning tokens in an automated feeder type device. Depending upon the physical arrangement of the feed arrangement, the device may be able to scan one or more of single sheets of material, joined sheets of material, or tokens made of different materials, such as paper or plastics, for example.

FIG. 8 shows further alternative physical configurations of a reader apparatus. In this example, the token is moved through the reader apparatus by a user. As shown in FIG. 8A, a reader housing 70 can be provided with a slot 71 therein for insertion of a token for scanning. An optics subassembly 20 can be provided with a scanning aperture directed into the slot 71 so as to be able to scan a token 62 passed through the slot. Additionally, guide elements 72 may be provided in the slot 71 to assist in guiding the token to the correct focal distance from the optics sub-assembly 20 and/or to provide for a constant speed passage of the token through the slot.

As shown in FIG. 8B, the reader apparatus may be configured to scan the token when moved along a longitudinal slot through the housing 70, as indicated by the arrow. Alternatively, as shown in FIG. 8C, the reader may be configured to scan the token when inserted into or removed from a slot extending into the reader housing 70, as indicated by the arrow. Devices of this type may be particularly suited to scanning tokens which are at least partially rigid, such as card, plastic or metal sheets.

FIG. 9 shows a schematic view of a reader apparatus 110 incorporated in a printing device 122. The reader apparatus can incorporate an optics subassembly 20 of the type described above. The printer 122 may be conventional other than for the inclusion of components that form the reader apparatus 110, such as the optics subassembly and any associated electronics.

To schematically represent the paper feed mechanism, only a final roller pair 109 is shown. It will be appreciated that the paper feed mechanism includes additional rollers and other mechanical parts. In a prototype example, the scan head forming part of the reader apparatus 110 is for convenience mounted as illustrated directly after the final roller pair. It will be appreciated that the scan head could be mounted in many different positions along the feed path of the paper. Moreover, although the illustration is of a laser printer, it will be appreciated that any kind of printing device could be used. As well as other forms of printer, such as inkjet printers, thermal printers or dot-matrix printers, the printing device could be any other kind of printing device not conventionally regarded as a printer, such as a networked photocopier machine, for example.

Thus there has now been described an example of an apparatus suitable for printing and scanning of a token. Thereby, the token may be scanned during production so as to avoid the possibility of a token being altered between production and scanning. This arrangement may also enable a reduced cost of ownership for such devices, as the increased cost of adding a scanning unit to a printer could be lower than the cost of a dedicated scanning device.

The above-described examples are based on localised excitation with a coherent light beam of small cross-section in combination with detectors that accept light signal scattered over a much larger area that includes the local area of excitation. It is possible to design a functionally equivalent optical system which is instead based on directional detectors that collect light only from localised areas in combination with excitation of a much larger area.

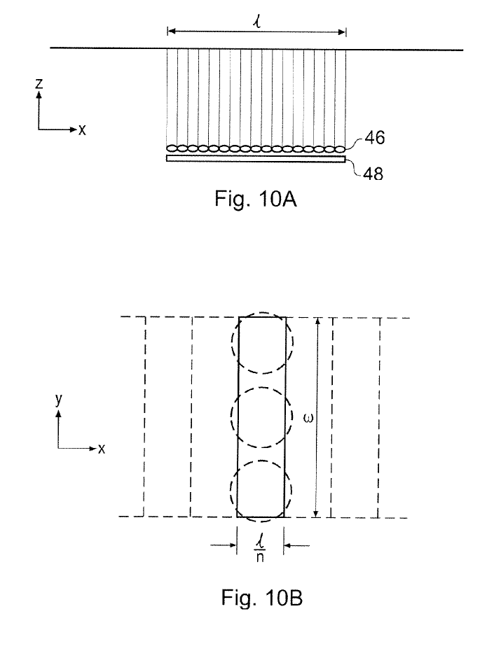

FIG. 10A shows schematically in side view an alternative imaging arrangement for a reader apparatus which is based on directional light collection and blanket illumination with a coherent beam. An array detector 48 is arranged in combination with a cylindrical microlens array 46 so that adjacent strips of the detector array 48 only collect light from corresponding adjacent strips in the reading volume. With reference to FIG. 4, each cylindrical microlens is arranged to collect light signal from one of the n sampling strips. The coherent illumination can then take place with blanket illumination of the whole reading volume (not shown in the illustration).

A hybrid system with a combination of localised excitation and localised detection may also be useful in some cases.

FIG. 10B shows schematically in plan view the optical footprint of a further alternative imaging arrangement for a reader apparatus in which directional detectors are used in combination with localised illumination with an elongate beam. This example may be considered to be a development of the example of FIG. 3 in which directional detectors are provided.

In this example three banks of directional detectors are provided, each bank being targeted to collect light from different portions along the ‘1×w’ excitation strip. The collection area from the plane of the reading volume are shown with the dotted circles, so that a first bank of, for example 2, detectors collects light signal from the upper portion of the excitation strip, a second bank of detectors collects light signal from a middle portion of the excitation strip and a third bank of detectors collects light from a lower portion of the excitation strip. Each bank of detectors is shown having a circular collection area of diameter approximately l/m, where m is the number of subdivisions of the excitation strip, where m=3 in the present example. In this way the number of independent data points can be increased by a factor of m for a given scan length l. As described further below, one or more of different banks of directional detectors can be used for a purpose other than collecting light signal that samples a speckle pattern. For example, one of the banks may be used to collect light signals in a way optimised for barcode scanning. If this is the case, it will generally be sufficient for that bank to contain only one detector, since there will be no advantage obtaining cross-correlations when only scanning for contrast.

FIG. 11 is a microscope image of a paper surface with the image covering an area of approximately 0.5×0.2 mm. This figure is included to illustrate that macroscopically flat surfaces, such as from paper, are in many cases highly structured at a microscopic scale. For paper, the surface is microscopically highly structured as a result of the intermeshed network of wood or other fibres that make up the paper.

The figure is also illustrative of the characteristic length scale for the wood fibres which is around 10 microns. This dimension has the correct relationship to the optical wavelength of the coherent beam of the present example to cause diffraction and hence speckle, and also diffuse scattering which has a profile that depends upon the fibre orientation. It will thus be appreciated that if a reader is to be designed for a specific class of token, the wavelength of the laser can be tailored to the structure feature size of the class of tokens to be scanned.

It is also evident from the figure that the local surface structure of each piece of paper will be unique in that it depends on how the individual wood fibres are arranged. A piece of paper is thus no different from a specially created token in that it has structure which is unique as a result of it being made by a process governed by laws of nature. The same applies to many other types of token.

In other words, it can be essentially pointless to go to the effort and expense of making specially prepared tokens, when unique characteristics are measurable in a straightforward manner from a wide variety of every day tokens. The data collection and numerical processing of a scatter signal that takes advantage of the natural structure of a token's surface (or interior in the case of transmission) is now described.

Having previously described the principal structural components and functional components of various reader apparatuses, the numerical processing used to determine a signature will now be described. It will be understood that this numerical processing can be implemented for the most part in a computer program that runs on a processor, with some elements subordinated to a PIC in various embodiments. In alternative examples, the numerical processing could be performed by a dedicated numerical processing device or devices implemented in various combinations of hardware, software and firmware.

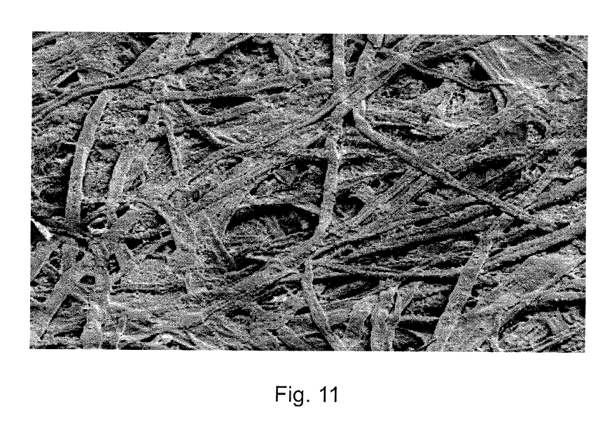

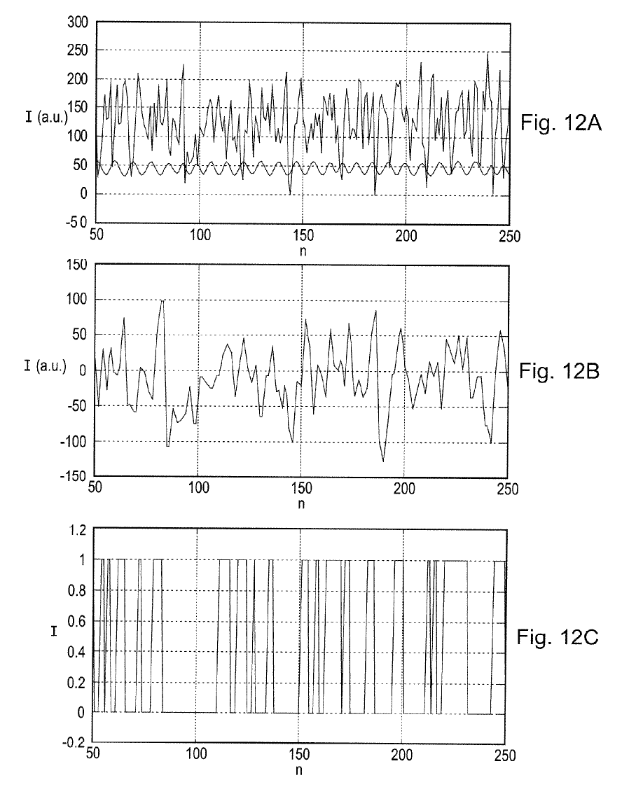

FIG. 12A shows raw data from a single photodetector 16a . . . d of the reader apparatus of FIG. 3. The graph plots signal intensity I in arbitrary units (a.u.) against point number n (see FIG. 4). The higher trace fluctuating between I=0-250 is the raw signal data from photodetector 16a. The lower trace is the encoder signal picked up from the markers 28 (see FIG. 4) which is at around I=50.

FIG. 12B shows the photodetector data of FIG. 12A after linearisation with the encoder signal (NB although the x axis is on a different scale from FIG. 12A, this is of no significance). As noted above, where a movement of the token relative to the scanner is sufficiently linear, there may be no need to make use of a linearisation relative to alignment marks. In addition, the average of the intensity has been computed and subtracted from the intensity values. The processed data values thus fluctuate above and below zero.

FIG. 12C shows the data of FIG. 12B after digitisation. The digitisation scheme adopted is a simple binary one in which any positive intensity values are set at one a.u. and any negative intensity values are set at zero a.u. It will be appreciated that multi-state digitisation could be used instead, or any one of many other possible digitisation approaches could also be used. The main important feature of the digitisation is merely that the same digitisation scheme is applied consistently.

FIG. 13 is a flow diagram showing how a signature is generated from a speckle pattern generated by illuminating a token with coherent radiation.

Step S1 is a data acquisition step during which the optical intensity at each of the photodetectors is acquired approximately every 1 ms during the entire length of scan. Simultaneously, the encoder signal is acquired as a function of time. It is noted that if the scan motor has a high degree of linearisation accuracy (e.g. as would a stepper motor) then linearisation of the data may not be required. The data is acquired by the PIC 30 taking data from the ADC 31. The data points are transferred in real time from the PIC 30 to the processor 34. Alternatively, the data points could be stored in memory in the PIC 30 and then passed to the processor 34 at the end of a scan. The number n of data points per detector channel collected in each scan is defined as N in the following. Further, the value aₖ(i) is defined as the i-th stored intensity value from photodetector k, where i runs from 1 to N. Examples of two raw data sets obtained from such a scan are illustrated in FIG. 12A.

Step S2 uses numerical interpolation to locally expand and contract aₖ(i) so that the encoder transitions are evenly spaced in time. This corrects for local variations in the motor speed. This step can be performed in the processor 34 by a computer program.

Step S3 is an optional step. If performed, this step numerically differentiates the data with respect to time. It may also be desirable to apply a weak smoothing function to the data. Differentiation may be useful for highly structured surfaces, as it serves to attenuate uncorrelated contributions from the signal relative to correlated (speckle) contributions.

Step S4 is a step in which, for each photodetector, the mean of the recorded signal is taken over the N data points. For each photodetector, this mean value is subtracted from all of the data points so that the data are distributed about zero intensity. Reference is made to FIG. 12B which shows an example of a scan data set after linearisation and subtraction of a computed average.

Step S5 digitises the analogue photodetector data to compute a digital signature representative of the scan. The digital signature is obtained by applying the rule: aₖ(i)>0 maps onto binary ‘1’ and aₖ(i)<=0 maps onto binary ‘0’. The digitised data set is defined as dₖ(i) where i runs from 1 to N. The signature of the token may incorporate further components in addition to the digitised signature of the intensity data just described. These further optional signature components are now described.

Step S6 is an optional step in which a smaller ‘thumbnail’ digital signature is created. This is done either by averaging together adjacent groups of m readings, or more preferably by picking every cth data point, where c is the compression factor of the thumbnail. The latter is preferred since averaging may disproportionately amplify noise. The same digitisation rule used in Step S5 is then applied to the reduced data set. The thumbnail digitisation is defined as tk(i) where i runs 1 to N/c and c is the compression factor.

Step S7 is an optional step applicable when multiple detector channels exist. The additional component is a cross-correlation component calculated between the intensity data obtained from different ones of the photodetectors. With 2 channels there is one possible cross-correlation coefficient, with 3 channels up to 3, and with 4 channels up to 6 etc. The cross-correlation coefficients are useful, since it has been found that they are good indicators of material type. For example, for a particular type of document, such as a passport of a given type, or laser printer paper, the cross-correlation coefficients always appear to lie in predictable ranges. A normalised cross-correlation can be calculated between ak(i) and al(i), where k≠l and k,l vary across all of the photodetector channel numbers. The normalised cross-correlation function F is defined as:

$$Γ ( k , l ) = \frac{{\sum }_{i = 1}^{N} {a}_{k} ( i ) {a}_{l} ( i )}{\sqrt{( {\sum }_{i = 1}^{N} {{a}_{k} ( i )}^{2} ) ( {\sum }_{i = 1}^{N} {{a}_{i} ( i )}^{2} )}}$$

Another aspect of the cross-correlation function that can be stored for use in later verification is the width of the peak in the cross-correlation function, for example the full width half maximum (FWHM). The use of the cross-correlation coefficients in verification processing is described further below.

Step S8 is another optional step which is to compute a simple intensity average value indicative of the signal intensity distribution. This may be an overall average of each of the mean values for the different detectors or an average for each detector, such as a root mean square (rms) value of ak(i). If the detectors are arranged in pairs either side of normal incidence as in the reader described above, an average for each pair of detectors may be used. The intensity value has been found to be a good crude filter for material type, since it is a simple indication of overall reflectivity and roughness of the sample. For example, one can use as the intensity value the unnormalised rms value after removal of the average value, i.e. the DC background.

The signature data obtained from scanning a token can be compared against records held in a signature database for verification purposes and/or written to the database to add a new record of the signature to extend the existing database.

A new database record will include the digital signature obtained in Step S5. This can optionally be supplemented by one or more of its smaller thumbnail version obtained in Step S6 for each photodetector channel, the cross-correlation coefficients obtained in Step S7 and the average value(s) obtained in Step S8. Alternatively, the thumbnails may be stored on a separate database of their own optimised for rapid searching, and the rest of the data (including the thumbnails) on a main database.

The process of generating a signature described above, can be used to generate the signatures at a token provider terminal 106 or a verification terminal 130.

FIG. 14 is a flow diagram showing how a signature obtained from a presented prescription can be verified against a signature database to determine whether the presented prescription is authentic.

In a simple implementation, the database 124 could simply be searched to find a match based on the full set of signature data. However, to speed up the verification process, the process can use the smaller thumbnails and pre-screening based on the computed average values and cross-correlation coefficients as now described.

Verification Step V1 is the first step of the verification process. At step 1, the system server 120 receives a signature or thumbnail of a signature generated according to the process described above, in relation to scan Steps S1 to S8, from a verification terminal 130.

Verification Step V2 takes each of the thumbnail entries and evaluates the number of matching bits between it and tk(i+j), where j is a bit offset which is varied to compensate for errors in placement of the scanned area. The value of j is determined and then the thumbnail entry which gives the maximum number of matching bits. This is the ‘hit’ used for further processing.

Verification Step V3 is an optional pre-screening test that is performed before analysing the full digital signature stored for the record against the scanned digital signature. In this pre-screen, the rms values obtained in Scan Step S8 are compared against the corresponding stored values in the database record of the hit. The ‘hit’ is rejected from further processing if the respective average values do not agree within a predefined range. The token is then rejected as non-verified (i.e. jump to Verification Step V6 and issue a response message indicating that the token could not be authenticated).

Verification Step V4 is a further optional pre-screening test that is performed before analysing the full digital signature. In this pre-screen, the cross-correlation coefficients obtained in Scan Step S7 are compared against the corresponding stored values in the database record of the hit. The ‘hit’ is rejected from further processing if the respective cross-correlation coefficients do not agree within a predefined range. The token is then rejected as non-verified (i.e. jump to Verification Step V6 and issue a response message indicating that the token could not be authenticated).

Another check using the cross-correlation coefficients that could be performed in Verification Step V4 is to check the width of the peak in the cross-correlation function, where the cross-correlation function is evaluated by comparing the value stored from the original scan in Scan Step S7 above and the re-scanned value:

$${Γ}_{k , l} ( j ) = \frac{{\sum }_{i = 1}^{N} {a}_{k} ( i ) {a}_{l} ( i + j )}{\sqrt{( {\sum }_{i = 1}^{N} {{a}_{k} ( i )}^{2} ) ( {\sum }_{i = 1}^{N} {{a}_{l} ( i )}^{2} )}}$$

If the width of the re-scanned peak is significantly higher than the width of the original scan, this may be taken as an indicator that the re-scanned token has been tampered with or is otherwise suspicious. For example, this check should beat a fraudster who attempts to fool the system by printing a bar code or other pattern with the same intensity variations that are expected by the photodetectors from the surface being scanned.

Verification Step V5 is the main comparison between the scanned digital signature obtained in Scan Step S5 and the corresponding stored values in the database record of the hit. The full stored digitised signature, dₖ^{db}(i) is split into n blocks of q adjacent bits on k detector channels, i.e. there are qk bits per block. A typical value for q is 4 and a typical value for k is 4, making typically 16 bits per block. The qk bits are then matched against the qk corresponding bits in the stored digital signature dₖ^{db}(i+j). If the number of matching bits within the block is greater or equal to some pre-defined threshold zₜₕᵣₑₛₕ, then the number of matching blocks is incremented. A typical value for zₜₕᵣₑₛₕ is 13. This is repeated for all n blocks. This whole process is repeated for different offset values of j, to compensate for errors in placement of the scanned area, until a maximum number of matching blocks is found. Defining M as the maximum number of matching blocks, the probability of an accidental match is calculated by evaluating:

$$p ( M ) = {\sum }_{w = n - M}^{n} {{s}^{w} ( 1 - s )}^{n - w} {}_{w}^{n} C$$

where s is the probability of an accidental match between any two blocks (which in turn depends upon the chosen value of z_{threshold}), M is the number of matching blocks and p(M) is the probability of M or more blocks matching accidentally. The value of s is determined by comparing blocks within the data base from scans of different objects of similar materials, e.g. a number of scans of paper documents etc.

For the case of q=4, k=4 and z_{threshold}=13, we typical value of s is 0.1. If the qk bits were entirely independent, then probability theory would give s=0.01 for z_{threshold}=13. The fact that a higher value is found empirically is because of correlations between the k detector channels and also correlations between adjacent bits in the block due to a finite laser spot width. A typical scan of a piece of paper yields around 314 matching blocks out of a total number of 510 blocks, when compared against the data base entry for that piece of paper. Setting M=314, n=510, s=0.1 for the above equation gives a probability of an accidental match of 10⁻¹⁷⁷.

Verification Step V6 issues a result of the verification process in a response message. The probability result obtained in Verification Step V5 may be used in a pass/fail test in which the benchmark is a pre-defined probability threshold. In this case the probability threshold may be set at a level by the system, or may be a variable parameter set at a level chosen by an administrator of the system server. Alternatively, the probability result may be output indicating a confidence level, either in raw form as the probability itself, or in a modified form using relative terms (e.g. no match/poor match/good match/excellent match) or other classification.

It will be appreciated that many variations are possible. For example, instead of treating the cross-correlation coefficients as a pre-screen component, they could be treated together with the digitised intensity data as part of the main signature. For example the cross-correlation coefficients could be digitised and added to the digitised intensity data. The cross-correlation coefficients could also be digitised on their own and used to generate bit strings or the like which could then be searched in the same way as described above for the thumbnails of the digitised intensity data in order to find the hits.

Thus there have now been described a number of examples of arrangements for scanning a token, such as a prescription, to obtain a signature based upon intrinsic properties of that token. There have also been described examples of how that signature can be generated from the data collected during the scan, and how the signature can be compared to a later scan from the same or a different token to provide a measure of how likely it is that the same token has been scanned in the later scan in order to verify the authenticity of the presented token.

In some examples, the method for extracting a signature from a scanned article can be optimised to provide reliable recognition of an article despite deformations to that article caused by, for example, stretching or shrinkage. Such stretching or shrinkage of an article may be caused by, for example, water damage to a paper or cardboard based article.

Also, an article may appear to a scanner to be stretched or shrunk if the relative speed of the article to the sensors in the scanner is non-linear. This may occur if, for example the article is being moved along a conveyor system, or if the article is being moved through a scanner by a human holding the article. An example of a likely scenario for this to occur is where a human scans, for example, a bank card using a scanner such as that described with reference to FIGS. 8A, 8B and 8C above.

As described above, where a scanner is based upon a scan head which moves within the scanner unit relative to an article held stationary against or in the scanner, then linearisation guidance can be provided by the optional distance marks 28 to address any non-linearities in the motion of the scan head. Where the article is moved by a human, these non-linearities can be greatly exaggerated

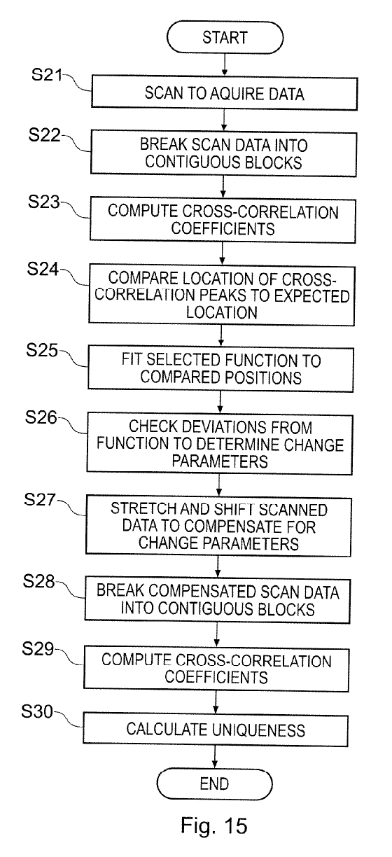

To address recognition problems which could be caused by these non-linear effects, it is possible to adjust the analysis phase of a scan of an article. Thus a modified validation procedure will now be described with reference to FIG. 15. The process implemented in this example uses a block-wise analysis of the data to address the non-linearities.

The process carried out in accordance with FIG. 15, can include some or all of the steps of smoothing and differentiating the data, computing and subtracting the mean, and digitisation for obtaining the signature and thumbnail described with reference to FIG. 10, but are not shown in FIG. 15 so as not to obscure the content of that figure.

As shown in FIG. 15, the scanning process for a validation scan using a block-wise analysis starts at step S21 by performing a scan of the article to acquire the date describing the intrinsic properties of the article. This scanned data is then divided into contiguous blocks (which can be performed before or after digitisation and any smoothing/differentiation or the like) at step S22. In one example, a scan length of 54 mm is divided into eight equal length blocks. Each block therefore represents a subsection of scanned area of the scanned article.

For each of the blocks, a cross-correlation is performed against the equivalent block for each stored signature with which it is intended that article be compared at step S23. This can be performed using a thumbnail approach with one thumbnail for each block. The results of these cross-correlation calculations are then analysed to identify the location of the cross-correlation peak. The location of the cross-correlation peak is then compared at step S24 to the expected location of the peak for the case were a perfectly linear relationship to exist between the original and later scans of the article.

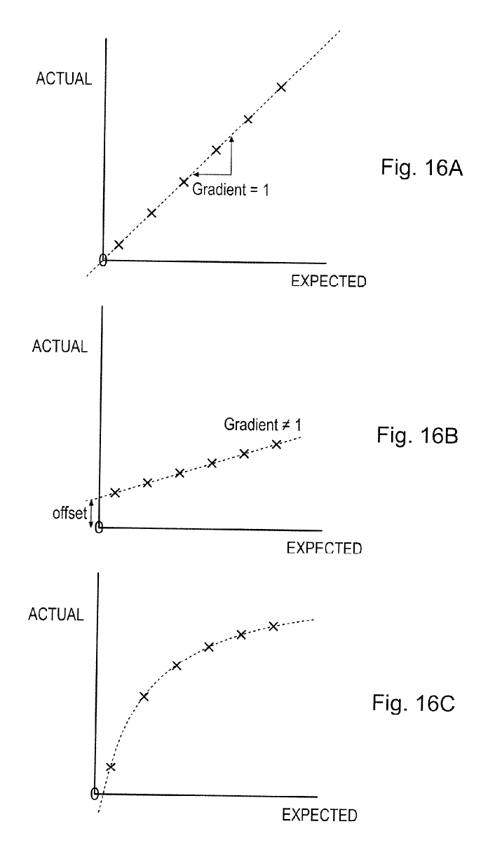

This relationship can be represented graphically as shown in FIGS. 16A, 16B and 136C. In the example of FIG. 16A, the cross-correlation peaks are exactly where expected, such that the motion of the scan head relative to the article has been perfectly linear and the article has not experienced stretch or shrinkage. Thus a plot of actual peak positions against expected peak results in a straight line which passes through the origin and has a gradient of 1.

In the example of FIG. 16B, the cross-correlation peaks are closer together than expected, such that the gradient of a line of best fit is less than one. Thus the article has shrunk relative to its physical characteristics upon initial scanning. Also, the best fit line does not pass through the origin of the plot. Thus the article is shifted relative to the scan head compared to its position upon initial scanning.

In the example of FIG. 16C, the cross correlation peaks do not form a straight line. In this example, they approximately fit to a curve representing a y² function. Thus the movement of the article relative to the scan head has slowed during the scan. Also, as the best fit curve does not cross the origin, it is clear that the article is shifted relative to its position upon initial scanning.

A variety of functions can be test-fitted to the plot of points of the cross-correlation peaks to find a best-fitting function. Thus curves to account for stretch, shrinkage, misalignment, acceleration, deceleration, and combinations thereof can be used.

Once a best-fitting function has been identified at step S25, a set of change parameters can be determined which represent how much each cross-correlation peak is shifted from its expected position at step S26. These compensation parameters can then, at step S27, be applied to the data from the scan taken at step S21 in order substantially to reverse the effects of the shrinkage, stretch, misalignment, acceleration or deceleration on the data from the scan. As will be appreciated, the better the best-fit function obtained at step S25 fits the scan data, the better the compensation effect will be.

The compensated scan data is then broken into contiguous blocks at step S28 as in step S22. The blocks are then individually cross-correlated with the respective blocks of data from the stored signature at step S29 to obtain the cross-correlation coefficients. This time the magnitude of the cross-correlation peaks are analysed to determine the uniqueness factor at step S29. Thus it can be determined whether the scanned article is the same as the article which was scanned when the stored signature was created.

Accordingly, there has now been described an example of a method for compensating for physical deformations in a scanned article, and for non-linearities in the motion of the article relative to the scanner. Using this method, a scanned article can be checked against a stored signature for that article obtained from an earlier scan of the article to determine with a high level of certainty whether or not the same article is present at the later scan. Thereby an article constructed from easily distorted material can be reliably recognised. Also, a scanner where the motion of the scanner relative to the article may be non-linear can be used, thereby allowing the use of a low-cost scanner without motion control elements.

In some scanner apparatuses, it is also possible that it may be difficult to determine where a scanned region starts and finishes. Of the examples discussed above, this is most problematic for the example of FIG. 8B, where an article to be scanned passes through a slot, such that the scan head may “see” more of an article than the intended scan area. One approach to addressing this difficulty would be to define the scan area as starting at the edge of the article. As the data received at the scan head will undergo a clear step change when an article is passed though what was previously free space, the data retrieved at the scan head can be used to determine where the scan starts.

In this example, the scan head is operational prior to the application of the article to the scanner. Thus initially the scan head receives data corresponding to the unoccupied space in front of the scan head. As the article is passed in front of the scan head, the data received by the scan head immediately changes to be data describing the article. Thus the data can be monitored to determine where the article starts and all data prior to that can be discarded. The position and length of the scan area relative to the article leading edge can be determined in a number of ways. The simplest is to make the scan area the entire length of the article, such that the end can be detected by the scan head again picking up data corresponding to free space. Another method is to start and/or stop the recorded data a predetermined number of scan readings from the leading edge. Assuming that the article always moves past the scan head at approximately the same speed, this would result in a consistent scan area. Another alternative is to use actual marks on the article to start and stop the scan region, although this may require more work, in terms of data processing, to determine which captured data corresponds to the scan area and which data can be discarded.

Thus there has now been described an number of techniques for scanning an item to gather data based on an intrinsic property of the article, compensating if necessary for damage to the article or non-linearities in the scanning process, and comparing the article to a stored signature based upon a previous scan of an article to determine whether the same article is present for both scans.

In some scanner apparatuses, it is also possible that it may be difficult to determine where a scanned region starts and finishes. Of the examples discussed above, this is most problematic for the example of FIG. 8B, where an article to be scanned passes through a slot, such that the scan head may “see” more of an article than the intended scan area. One approach to addressing this difficulty would be to define the scan area as starting at the edge of the article. As the data received at the scan head will undergo a clear step change when an article is passed though what was previously free space, the data retrieved at the scan head can be used to determine where the scan starts.

In this example, the scan head is operational prior to the application of the article to the scanner. Thus initially the scan head receives data corresponding to the unoccupied space in front of the scan head. As the article is passed in front of the scan head, the data received by the scan head immediately changes to be data describing the article. Thus the data can be monitored to determine where the article starts and all data prior to that can be discarded. The position and length of the scan area relative to the article leading edge can be determined in a number of ways. The simplest is to make the scan area the entire length of the article, such that the end can be detected by the scan head again picking up data corresponding to free space. Another method is to start and/or stop the recorded data a predetermined number of scan readings from the leading edge. Assuming that the article always moves past the scan head at approximately the same speed, this would result in a consistent scan area. Another alternative is to use actual marks on the article to start and stop the scan region, although this may require more work, in terms of data processing, to determine which captured data corresponds to the scan area and which data can be discarded.

Thus there has now been described an number of techniques for scanning an item to gather data based on an intrinsic property of the article, compensating if necessary for damage to the article or non-linearities in the scanning process, and comparing the article to a stored signature based upon a previous scan of an article to determine whether the same article is present for both scans.

Another characteristic of an article which can be detected using a block-wise analysis of a signature generated based upon an intrinsic property of that article is that of localised damage to the article. For example, such a technique can be used to detect modifications to an article made after an initial record scan.

For example, many documents, such as passports, ID cards and driving licenses, include photographs of the bearer. If an authenticity scan of such an article includes a portion of the photograph, then any alteration made to that photograph will be detected. Taking an arbitrary example of splitting a signature into 10 blocks, three of those blocks may cover a photograph on a document and the other seven cover another part of the document, such as a background material. If the photograph is replaced, then a subsequent rescan of the document can be expected to provide a good match for the seven blocks where no modification has occurred, but the replaced photograph will provide a very poor match. By knowing that those three blocks correspond to the photograph, the fact that all three provide a very poor match can be used to automatically fail the validation of the document, regardless of the average score over the whole signature.

Also, many documents include written indications of one or more persons, for example the name of a person identified by a passport, driving license or identity card, or the name of a bank account holder. Many documents also include a place where written signature of a bearer or certifier is applied. Using a block-wise analysis of a signature obtained therefrom for validation can detect a modification to alter a name or other important word or number printed or written onto a document. A block which corresponds to the position of an altered printing or writing can be expected to produce a much lower quality match than blocks where no modification has taken place. Thus a modified name or written signature can be detected and the document failed in a validation test even if the overall match of the document is sufficiently high to obtain a pass result.

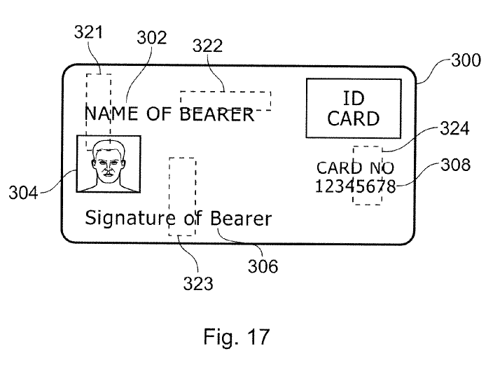

An example of an identity card 300 is shown in FIG. 17. The identity card 300 includes a printed bearer name 302, a photograph of the bearer 304, a signature of the bearer 306 (which may be written onto the card, or printed from a scan of a written signature or a signature captured electronically), and a printed card number 308. In order to protect against fraudulent alteration to the identity card, a scan area for generating a signature based upon an intrinsic property of the card can include one or more of those elements. Various example scan areas are marked in FIG. 15 to illustrate the possibilities. Example scan area 321 includes part of the printed name 302 and part of the photograph 304. Example scan area 322 includes part of the printed name. Example scan area 323 includes part of the signature 306. Example scan area 324 includes part of the card number 308.

The area and elements selected for the scan area can depend upon a number of factors, including the element of the document which it is most likely that a fraudster would attempt to alter. For example, for any document including a photograph the most likely alteration target will usually be the photograph as this visually identifies the bearer. Thus a scan area for such a document might beneficially be selected to include a portion of the photograph. Another element which may be subjected to fraudulent modification is the bearer's signature, as it is easy for a person to pretend to have a name other than their own, but harder to copy another person's signature. Therefore for signed documents, particularly those not including a photograph, a scan area may beneficially include a portion of a signature on the document.

In the general case therefore, it can be seen that a test for authenticity of an article can comprise a test for a sufficiently high quality match between a verification signature and a record signature for the whole of the signature, and a sufficiently high match over at least selected blocks of the signatures. Thus regions important to the assessing the authenticity of an article can be selected as being critical to achieving a positive authenticity result.

In some examples, blocks other than those selected as critical blocks may be allowed to present a poor match result. Thus a document may be accepted as authentic despite being torn or otherwise damaged in parts, so long as the critical blocks provide a good match and the signature as a whole provides a good match.

Thus there have now been described a number of examples of a system, method and apparatus for identifying localised damage to an article, and for rejecting an inauthentic an article with localised damage or alteration in predetermined regions thereof. Damage or alteration in other regions may be ignored, thereby allowing the document to be recognised as authentic.

When using a biometric technique such as the identity technique described with reference to FIGS. 1 to 17 above for the verification of the authenticity or identity of an article, difficulties can arise with the reproducibility of signatures based upon biometric characteristics. In particular, as well as the inherent tendency for a biometric signature generation system to return slightly different results in each signature generated from an article, where an article is subjected to a signature generation process at different signature generation apparatuses and at different times there is the possibility that a slightly different portion of the article is presented on each occasion, making reliable verification more difficult.

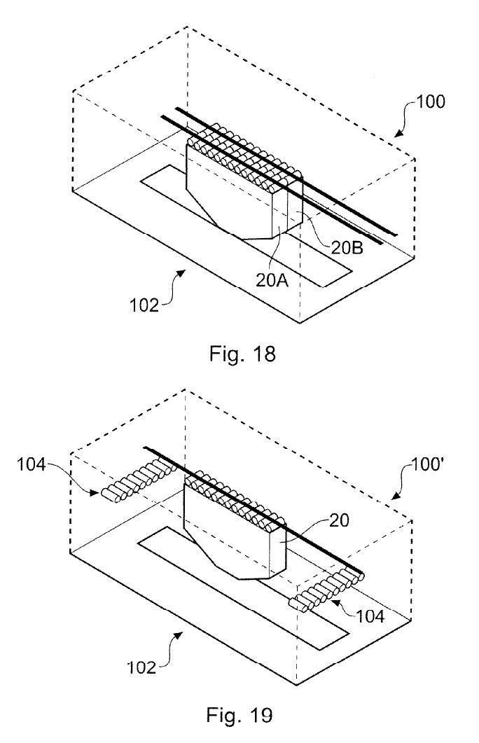

Examples of systems, methods and apparatuses for addressing these difficulties will now be described. First, with reference to FIG. 18, a multi-scan head signature generation apparatus for database creation will be described.

As shown in FIG. 18, a reader unit 400 can include two optics subassemblies 20, each operable to create a signature for an article presented in a reading volume 402 of the reader unit. Thus an item presented for scanning to create a signature for recording of the item in an item database against which the item can later be verified, can be scanned twice, to create two signatures, spatially offset from one another by a likely alignment error amount. Thus a later scan of the item for identification or authenticity verification can be matched against both stored signatures. In some examples, a match against one of the two stored signatures can be considered as a successful match.

In some examples, further read heads can be used, such that three, four or more signatures are created for each item. Each scan head can be offset from the others in order to provide signatures from positions adjacent the intended scan location. Thus greater robustness to article misalignment on verification scanning can be provided.

The offset between scan heads can be selected dependent upon factors such as a width of scanned portion of the article, size of scanned are relative to the total article size, likely misalignment amount during verification scanning, and article material.

Thus there has now been described a system for scanning an article to create a signature database against which an article can be checked to verify the identity and/or authenticity of the article.

An example of another system for providing multiple signatures in an article database will now be describe with reference to FIG. 19.

As shown in FIG. 16, a reader unit 400′ can have a single optic subassembly 20 and an alignment adjustment unit 404. In use, the alignment adjustment unit 404 can alter the alignment of the optics subassembly 20 relative to the reading volume 402 of the reader unit. Thus an article placed in the reading volume can be scanned multiple times by the optics subassembly 20 in different positions so as to create multiple signatures for the article. In the present example, the alignment adjustment unit 404 can adjust the optics subassembly to read from two different locations. Thus a later scan of the item for identification or authenticity verification can be matched against both stored signatures. In some examples, a match against one of the two stored signatures can be considered as a successful match.

In some examples, further read head positions can be used, such that three, four or more signatures are created for each item. Each scan head position can be offset from the others in order to provide signatures from positions adjacent the intended scan location. Thus greater robustness to article misalignment on verification scanning can be provided.

The offset between scan head positions can be selected dependent upon factors such as a width of scanned portion of the article, size of scanned are relative to the total article size, likely misalignment amount during verification scanning, and article material.

Thus there has now been described another example of a system for scanning an article to create a signature database against which an article can be checked to verify the identity and/or authenticity of the article.

Although it has been described above that a scanner used for record scanning (i.e. scanning of articles to create reference signatures against which the article can later be validated) can use multiple scan heads and/or scan head positions to create multiple signatures for an article, it is also possible to use a similar system for later validation scanning.

For example, a scanner for use in a validation scan may have multiple read heads to enable multiple validation scan signatures to be generated. Each of these multiple signatures can be compared to a database of recorded signatures, which may itself contain multiple signatures for each recorded item. Due to the fact that, although the different signatures for each item may vary these signatures will all still be extremely different to any signatures for any other items, a match between any one record scan signature and any one validation scan signature should provide sufficient confidence in the identity and/or authenticity of an item.

A multiple read head validation scanner can be arranged much as described with reference to FIG. 18 above. Likewise, a multiple read head position validation scanner can be arranged much as described with reference to FIG. 18 above. Also, for both the record and validation scanners, a system of combined multiple scan heads and multiple scan head positions per scan head can be combined into a single device.

While the invention is susceptible to various modifications and alternative forms, specific embodiments are shown by way of example in the drawings and are herein described in detail. It should be understood, however, that the drawings and corresponding detailed description are not intended to limit the invention to the particular form disclosed, but on the contrary, the invention is to cover all modifications, equivalents and alternatives falling within the scope of the present invention as defined by the appended claims.

For example, those skilled in the art will be aware that various operations performed by the system or implemented by methods described herein could be provided by one or more of hardware, firmware and software elements. For example, conventional computer systems could be programmed in order to implement a verification processor, a system server and a token provider terminal.

Those skilled in the art would also be aware that a token provider terminal could be used to scan a token, such as a prescription hand-written by a doctor, in order to provide a signature without the token provider terminal itself being used to produce the token. E.g. the token provider terminal could operate only in a signature scanning mode.

It would also be understood that many token provider terminals at various different locations can be connected to a network. For example, many pharmacies may each be provided with a token provider terminal. Such token provider terminals could be existing computer systems that are configured by software to add the necessary functionality to operate as part of a system according to the present invention.

Moreover, for further security it would be clear to the skilled man that signatures may be obtained from an area of a token after it has been prescribed. For example, the signature may be obtained from an area of a prescription after information has been printed in that area, or after a doctor has signed a hand-written signature in that area.

Viewed from another aspect, the present invention provides a system for verifying the authenticity of prescriptions in order to control access to prescription drugs, the system comprising a prescription issuer terminal provided at a first location and operably coupled to a network, the prescription issuer terminal being operable at the first location to generate a first signature from a prescription written, printed or otherwise prescribed at the first location based upon a speckle pattern generated by illuminating the prescription with coherent radiation, an authentication server operably coupled to the network, the authentication server being operable to store a plurality of prescription signatures transmitted over the network from one or more prescription issuer terminals, the authentication server being further operable to compare a signature transmitted over the network with stored signatures and transmit a response message indicating whether or not the transmitted signature is considered to match any stored signature, and a dispensary terminal operably coupled to the network and provided at a second location remote from the first location, the dispensary terminal being operable to verify the authenticity of a prescription presented at the second location by generating a second signature from the presented prescription, transmitting the second signature to the authentication server via the network, receiving a response message over the network, and identifying as authentic the presented prescription when a signature matching the second signature is present at the authentication server.

Viewed from a further aspect, the present invention provides a method for verifying the authenticity of prescriptions in order to control access to prescription drugs, the method comprising prescribing a prescription at a first location, generating a first signature at the first location based upon a speckle pattern generated by illuminating the prescription with coherent radiation, transmitting the signature to an authentication server, storing the signature at the authentication server, generating a second signature from a presented prescription at a second location remote from the first location, wherein the second signature is based upon a speckle pattern generated by illuminating the presented prescription with coherent radiation, transmitting the second signature to the authentication server, identifying whether the second signature matches any signatures stored by the authentication server, and verifying that the presented prescription is authentic when there is a matching signature at the authentication server.

Viewed from another aspect, the present invention provides a system for verifying the authenticity of prescriptions used to control the dispensing of medicaments, comprising a network means for providing one or more communications channels between devices operably coupled thereto, a token provider means provided at a first location and operably coupled to the network means, the token provider means being operable to generate a first signature from a medicament entitlement token prescribed at the first location based upon a speckle pattern generated by illuminating the medicament entitlement token with coherent radiation, a system server means operably coupled to the network means, the system server means being operable to store a plurality of signatures transmitted over the network means from one or more token provider means, the system server means being further operable to compare a signature transmitted over the network means with stored signatures and transmit a response message indicating whether or not the transmitted signature is considered to match any stored signature, and a verification means operably coupled to the network means and provided at a second location remote from the first location, the verification means being operable to verify the authenticity of a medicament entitlement token presented at the second location by generating a second signature from the presented medicament entitlement token based upon a speckle pattern generated by illuminating the presented medicament entitlement token with coherent radiation, transmitting the second signature to the system server means via the network means, receiving a response message over the network means and identifying as authentic the presented medicament entitlement token where the response message indicates there is a match between the second signature and a stored signature.

Viewed from a further aspect, the present invention provides a method for verifying the authenticity of prescriptions used to control the dispensing of medicaments, the method comprising a step of prescribing a medicament entitlement token at a first location, a step of generating a first signature at the first location based upon a speckle pattern generated by illuminating the medicament entitlement token with coherent radiation, a step of transmitting the first signature to a system server, a step of storing the signature at the system server, a step of generating a second signature from a presented medicament entitlement token at a second location remote from the first location, a step of transmitting the second signature to the system server, a step of identifying whether the second signature matches any signatures stored by the server system, a step of generating a response message identifying whether or not the second signature matches a stored signature, a step of transmitting the response message to the second location, and a step of verifying that the presented token is authentic at the second location where the response message indicates there is a match between the second signature and a stored signature.

Viewed from yet another aspect, the present invention provides a token provider terminal operable to generate a signature from a drug prescription based upon a speckle pattern generated by illuminating the drug prescription with coherent radiation, and transmit the signature to a remote server for storing for use in later identifying the drug prescription when it is presented to obtain prescription drugs.

### REFERENCES

1. JP-2003162581
2. GB-A-2 360 977
3. JP-2004212504
4. AU-A1-2004203532
5. U.S. Pat. No. 0,232,219 A1
6. GB-A-2 398 270
7. GB 0420524.1
8. U.S. 60/610,075
9. GB 0405641.2
10. U.S. 60/601,463
11. GB 0418138.4
12. GB 0509635.9
13. GB 0418178.0
14. GB 0418173.1

Where permitted, the content of the above-mentioned references are hereby also incorporated into this application by reference in their entirety.

1. A system for verifying the authenticity of prescriptions used to control the dispensing of medicaments, comprising:
a network for providing one or more communications channels between devices operably coupled thereto;
a token provider terminal provided at a first location and operably coupled to the network, the token provider terminal being operable to generate a first signature from a medicament entitlement token prescribed at the first location based upon a speckle pattern generated by sequentially illuminating a plurality of regions of the medicament entitlement token with coherent radiation;
a system server operably coupled to the network, the system server being operable to store a plurality of signatures transmitted over the network from one or more token provider terminals, the system server being further operable to compare a signature transmitted over the network with stored signatures and transmit a response message indicating whether or not the transmitted signature is considered to match any stored signature; and
a verification terminal operably coupled to the network and provided at a second location remote from the first location, the verification terminal being operable to verify the authenticity of a medicament entitlement token presented at the second location by generating a second signature from the presented medicament entitlement token based upon a speckle pattern generated by sequentially illuminating a plurality of regions of the presented medicament entitlement token with coherent radiation, transmitting the second signature to the system server via the network, receiving a response message over the network and identifying as authentic the presented medicament entitlement token where the response message indicates there is a match between the second signature and a stored signature.

2. The system of claim 1, wherein the token provider terminal further includes a reader apparatus, wherein the reader apparatus comprises:
a reading volume for receiving the medicament entitlement token;
a source for generating coherent radiation within the reading volume; and
a detector arrangement arranged to collect a set of data points from signals obtained when coherent radiation scatters from the reading volume, wherein different ones of the data points relate to scatter from different parts of the reading volume.

3. The system of claim 2, wherein the reader apparatus is incorporated into a printing device, the printing device further comprising:
a print head for printing the medicament entitlement token; and
a feed mechanism operable to convey the medicament entitlement token past the print head and the reader apparatus.

4. The system of claim 2, wherein the token provider terminal comprises a processor that is operable to determine the first signature from the set of data points.

5. The system of claim 1, wherein the token provider terminal is further operable to provide a user interface at the first location for prescribing medicament entitlement tokens.

6. The system of claim 1, wherein the token provider terminal is further operable to provide additional information relating to the medicament entitlement token to the server system via the network.

7. The system of claim 1, wherein the token provider terminal is further operable to generate a bearer identification signature based upon a speckle pattern generated by sequentially illuminating a plurality of regions of an identification token with coherent radiation and to transmit the bearer identification signature to the server system.

8. The system of claim 7, wherein the verification terminal is further operable to read the bearer identification signature from the identification token when presented at the second location.

9. The system of claim 1, wherein the verification terminal is further operable to indicate to the server system when one or more prescription item has been dispensed so that the server system can remove, invalidate or partially invalidate a stored signature corresponding to the prescription.

10. The system of claim 1, wherein the verification terminal is further operable automatically to track an inventory at the second location.

11. The system of claim 10, wherein the verification terminal is further operable automatically to place an order to a supplier over the network for replacement stock when the stock of one or more items in the inventory falls to or below a predetermined amount.

12. The system of claim 1, wherein the medicament entitlement token comprises a prescription printed on paper.

13. A computer program product for configuring the token provider terminal of claim 1.

14. A computer program product for configuring the verification terminal of claim 1.

15. A computer program product for configuring the system server of claim 1.

16. Use of the system of claim 1 to verify the authenticity of a medicament entitlement token presented at the second location.

17. Use of the system of claim 1 to ascertain whether a medicament entitlement token has been tampered with.

18. Use of the system of claim 1 to determine whether a bearer of a medicament entitlement token is authorised to use that medicament entitlement token.

19. A method for verifying the authenticity of prescriptions used to control the dispensing of medicaments, the method comprising:
prescribing a medicament entitlement token at a first location;
generating a first signature at the first location based upon a speckle pattern generated by sequentially illuminating a plurality of regions of the medicament entitlement token with coherent radiation;
transmitting the first signature to a system server;
storing the signature at the system server;
generating a second signature from a presented medicament entitlement token at a second location remote from the first location, wherein the second signature is based upon a speckle pattern generated by sequentially illuminating a plurality of regions of the presented medicament entitlement token with coherent radiation;
transmitting the second signature to the system server;
identifying whether the second signature matches any signatures stored by the server system;
generating a response message identifying whether or not the second signature matches a stored signature;
transmitting the response message to the second location; and
verifying that the presented token is authentic at the second location where the response message indicates there is a match between the second signature and a stored signature.

20. The method of claim 19, wherein generating a first or a second signature further comprises collecting a set of data points from signals obtained when coherent radiation scatters from a reading volume that is for receiving a token, wherein different ones of the data points relate to scatter from different parts of the reading volume.

21. The method of claim 19, wherein the medicament entitlement token is produced by printing.

22. The method of claim 19, further comprising providing a user interface operable to prescribe medicament entitlement tokens at the first location.

23. The method of claim 19, further comprising transmitting additional information relating to the medicament entitlement token from the first location to the server system.

24. The method of claim 19, further comprising:
generating a bearer identification signature at the first location, wherein the bearer identification signature is based upon a speckle pattern generated by sequentially illuminating a plurality of regions of an identification token with coherent radiation; and
transmitting the bearer identification signature to the server system.

25. The method of claim 24, further comprising reading a bearer identification signature from a presented identification token when presented at the second location and validating the authenticity of the presented identification token by comparing the bearer identification signature that is read to bearer identification signatures stored by the server system.

26. The method of claim 19, further comprising notifying the server system when one or more prescription item has been dispensed so that the server system can remove, invalidate or partially invalidate a stored signature corresponding to the prescription.

27. The method of claim 19, further comprising automatically tracking an inventory at the second location.

28. The method of claim 27, further comprising automatically placing an order to a supplier for replacement stock when the stock of one or more items in the inventory falls to or below a predetermined amount.

29. The method of claim 19, wherein the medicament entitlement token comprises a prescription printed on paper.

30. A computer program product operable to implement the method of claim 19.

31. A system for verifying the authenticity of prescriptions in order to control access to prescription drugs, comprising:
a prescription issuer terminal provided at a first location and operably coupled to a network, the prescription issuer terminal being operable at the first location to generate a first signature from a prescription prescribed at the first location based upon a speckle pattern generated by sequentially illuminating a plurality of regions of the prescription with coherent radiation;
an authentication server operably coupled to the network, the authentication server being operable to store a plurality of prescription signatures transmitted over the network from one or more prescription issuer terminals, the authentication server being further operable to compare a signature transmitted over the network with stored signatures and transmit a response message indicating whether or not the transmitted signature is considered to match any stored signature; and
a dispensary terminal operably coupled to the network and provided at a second location remote from the first location, the dispensary terminal being operable to verify the authenticity of a prescription presented at the second location by generating a second signature from the presented prescription, transmitting the second signature to the authentication server via the network, receiving a response message over the network, and identifying as authentic the presented prescription when a signature matching the second signature is present at the authentication server.

32. A method for verifying the authenticity of prescriptions in order to control access to prescription drugs, the method comprising:
prescribing a prescription at a first location;
generating a first signature at the first location based upon a speckle pattern generated by sequentially illuminating a plurality of regions of the prescription with coherent radiation;
transmitting the signature to an authentication server;
storing the signature at the authentication server;
generating a second signature from a presented prescription at a second location remote from the first location, wherein the second signature is based upon a speckle pattern generated by sequentially illuminating a plurality of regions of the presented prescription with coherent radiation;
transmitting the second signature to the authentication server;
identifying whether the second signature matches any signatures stored by the authentication server; and
verifying that the presented prescription is authentic when there is a matching signature at the authentication server.

33. A token provider terminal operable to:
generate a signature from a drug prescription based upon a speckle pattern generated by sequentially illuminating a plurality of regions of the drug prescription with coherent radiation; and
transmit the signature to a remote server for storing for use in later identifying the drug prescription when it is presented to obtain prescription drugs.

34. The token provider terminal of claim 33, comprising a reader apparatus, wherein the reader apparatus comprises:
a reading volume for receiving the drug prescription;
a source for generating coherent radiation within the reading volume; and
a detector arrangement arranged to collect a set of data points from signals obtained when coherent radiation scatters from the reading volume, wherein different ones of the data points relate to scatter from different parts of the reading volume.

35. The token provider terminal of claim 34, wherein the reader apparatus is incorporated into a printing device, the printing device further comprising:
a print head for printing the drug prescription; and
a feed mechanism operable to convey the drug prescription past the print head and the reader apparatus.

36. The token provider terminal of claim 34, wherein the token provider terminal comprises a processor that is operable to determine the signature from the set of data points.

37. The token provider terminal of claim 33, further operable to provide a user interface for generating drug prescriptions.

38. The token provider terminal of claim 33, further operable to provide additional information relating to the drug prescription to a server system via a network.

39. The token provider terminal of claim 33, further operable to generate a bearer identification signature based upon a speckle pattern generated by sequentially illuminating a plurality of regions of an identification token with coherent radiation and to transmit the bearer identification signature to a server system.

40. Use of the token provider terminal of claim 33 to generate a signature for use in later identifying the prescription when it is presented to obtain prescription drugs.
